(19) United States
(12) Patent Application Publication
(10) Pub. No.: US 2014/0306881 A1
(43) Pub. Date: Oct. 16, 2014

(54) WEARABLE DEVICE, PROGRAM AND DISPLAY CONTROLLING METHOD OF WEARABLE DEVICE

(71) Applicant: OLYMPUS CORPORATION, Tokyo (JP)

(72) Inventors: Ryohei SUGIHARA, Tokyo (JP); Seiji TATSUTA, Tokyo (JP); Teruo TOMITA, Tokyo (JP)

(73) Assignee: OLYMPUS CORPORATION, Tokyo (JP)

(21) Appl. No.: 14/253,044

(22) Filed: Apr. 15, 2014

(30) Foreign Application Priority Data
Apr. 15, 2013 (JP) 2013-084895

(51) Int. Cl. G06F 3/01; G02B 27/01; G06F 3/0481

(52) U.S. Cl. CPC G06F 3/013; G06F 3/04817; G02B 27/0172; G02B 2027/0178
USPC 345/156

(57) ABSTRACT

A wearable device configured to be worn by a wearer, the wearable device includes a display to provide an image on a display area that occupies a part of a field of view of the wearer, an eyesight sensor to acquire eyesight sensing information by an eyesight sensing in a field of view of the eyesight sensor, a peripheral sensing acquisition section to acquire peripheral sensing information from a peripheral sensing having a detection angle larger than an angle of the field of view of the eyesight sensor, and a display controller to control displaying object information of an object in the image, the object being selected from at least one candidate object recognized by at least one of the eyesight sensing and the peripheral sensing.

This application claims priority to Japanese Patent Application No. 2013-084895 filed on Apr. 15, 2013, the contents of which are incorporated herein by reference in entirety.

### BACKGROUND

The present invention generally relates to a wearable device, a program and a display controlling method of the wearable device.

Recently, a way of thinking called “Internet of Things” has been known. This is considered as the networked world where every “thing” placed in the daily environment has information.

For example, every electrical appliance placed in the home and the office (such as, for example, a refrigerator or an air-conditioner) becomes a so-called “smart electrical appliance” and each electrical appliance is connected to one or more networks (such as, for example, the Internet) and performs transmission of the information. Also, “the thing” is not limited to electronic devices (such as, for example, home electrical appliances) and other items (such as, for example, a garden plant, a water tank, every product exhibited on the shelf of a store) can become a target.

When many “things” are connected to the network and such “things” perform transmission of information in this way, a choice of the information is necessary if it is considered from a given viewpoint of the user. For example, if a user acquires the information of a product which is not relevant for the user, it is not useful. And because an amount of information that is sent on a network is enormous, it is not realistic for the user to read all information.

It is conceivable that some kind of sensing processing is performed and the information of an object which is sensed is acquired on this occasion. For example, a technique to know a surrounding (using information acquired from a sensor embedded circumferentially) for display in a Head Mount Display is disclosed in JP-A-2010-151867. Also, a technique to display related information of a picked up object on a display device after the image which picked up field of view forward is analyzed with a database is disclosed in JP-A-2012-155313.

### SUMMARY

In one aspect, provided is a wearable device configured to be worn by a wearer, the wearable device comprising: a display to provide an image on a display area that occupies a part of a field of view of the wearer, an eyesight sensor to acquire eyesight sensing information by an eyesight sensing in a field of view of the eyesight sensor, a peripheral sensing acquisition section to acquire peripheral sensing information by a peripheral sensing having a detection angle larger than an angle of the field of view of the eyesight sensor, and a display controller to control displaying object information of an object in the image, the object being selected from at least one candidate object recognized by at least one of the eyesight sensing and the peripheral.

In another aspect, provided is a computer program product storing a program code that, when executed by a computer, implements control of: an eyesight sensor to acquire eyesight sensing information by eyesight sensing in a field of view of the eyesight sensor, a peripheral sensing acquisition section to acquire peripheral sensing information by a peripheral sensing having a detection angle larger than an angle of the field of view of the eyesight sensor, and a display controller to control displaying object information of an object in the image, the object being selected from at least one candidate object recognized by at least one of the eyesight sensing and the peripheral sensing.

In another aspect, provided is a display controlling method of a wearable device configured to be worn by a wearer, the wearable device having a display to provide an image on a display area that occupies a part of a field of view of the wearer, comprising: acquiring eyesight sensing information by eyesight sensing in a field of view of the eyesight sensing, acquiring peripheral sensing information by peripheral sensing having a detection angle larger than an angle of the field of view of the eyesight sensing, and controlling displaying object information of an object in the image, the object being selected from at least one candidate object recognized by at least one of the eyesight sensing and the peripheral sensing.

### BRIEF DESCRIPTION OF THE DRAWINGS

FIG. 1 is a system constitution example of a wearable device of an embodiment.

FIG. 2 is a relationship figure of a wearable device, an object and the sensing range.

FIG. 3 is a figure to describe an example in which sensing of an object is performed through one or more electronic devices such as, for example, a cell-phone.

FIG. 4 is an example of a pickup image.

FIG. 5 is an example of the display image when an icon is displayed as the object information.

FIG. 6 is an example of the display image when list display is performed as the object information.

FIG. 7 is an example of the display image when a control screen is displayed as the object information.

FIG. 8A and FIG. 8B are figures that describe an outside world field of vision and a display area.

FIG. 9 is a figure which describes a view of the world of Internet of Things.

FIG. 10 is a flow chart which describes selection processing in the display control.

### DETAILED DESCRIPTION

According to one embodiment of the invention, having performed at least one of eyesight sensing and peripheral sensing, a wearable device, a program controlling display to show appropriate information to a wearer and a display control method of the wearable device may be provided.

According to one embodiment of the invention, there is provided a wearable device that may be configured to be worn by a wearer, wherein the wearable device may comprise: a display to provide an image on a display area that occupies a part of a field of view of the wearer, an eyesight sensor to acquire eyesight sensing information by an eyesight sensing in a field of view of the eyesight sensor, a peripheral sensing acquisition section to acquire peripheral sensing information from a peripheral sensing having a detection angle larger than an angle of the field of view of the eyesight sensor, and a display controller to control displaying object information of an object in the image, the object being selected from at least one candidate object recognized by at least one of eyesight sensing and peripheral sensing acquisition section.

In one aspect of the invention, the display controller may control displaying among the at least one candidate object, the object information of the object that may be recognized by the eyesight sensing.

Thereby, it is enabled to show the information of the object that is more relevant for a wearer based on eyesight sensing.

Also, in one aspect of the invention, the display controller may control displaying among the at least one candidate object, the object information of the object that is recognized by both the eyesight sensing and the peripheral sensing.

Thereby, it is enabled to show the information of the object that is more relevant for a wearer based on being an object recognized in both eyesight sensing and peripheral sensing.

Also, in one aspect of the invention, the display controller may control displaying a control screen having control instructions for controlling of the object whose object information is being displayed.

Thereby, the control screen can be displayed as object information.

Also, in one aspect of the invention, the wearable device may further include a communication section configured to communicate with an electronic device as the object, wherein the communication section may be configured to transmit a signal of a control instruction to the electronic device based on an operation of the control screen by the wearer. Thereby, it is enabled to control the object by transmitting a control signal corresponding to the operation when the operation based on the control screen is carried out

Also, in one aspect of the invention, the eyesight sensor may be configured to pick up an image in the field of the eyesight sensor as the eyesight sensing and may acquire the eyesight sensing information based on image processing of the image.

Also, in one aspect of the invention, the peripheral sensing acquisition section may be configured to receive at least one signal concerning a position of the wearer and a position of the object so as to acquire information of a position of the object relative to a position of the wearer based on the signal received.

Also, in one aspect of the invention, the display controller may control displaying an icon of one to N which expresses an object of one to N as the object information wherein N is an integer and is more than one, and when a selection processing of selecting an icon i is performed among the icons of the one to N, the display controller may control displaying the control screen used as the control instruction of the object i corresponding to the icon I, wherein i is an integer satisfying 1≦i≦N.

Thereby, after having displayed a plurality of icons, it is enabled to display the control screen of the object corresponding to the selected icon from that.

Also, when the selection is not performed by the wearer within a predetermined term, the display controller may automatically select a single icon among the icons and control displaying the control screen of the object corresponding to the icon selected.

Thereby, it is enabled to shift the display of the control screen automatically because the wearable device selects one object automatically when the selection by the wearer is not made.

Also, the display controller may control displaying an icon representing the object as the object information, wherein the display controller may control displaying the icon of the object as a first form when the object is recognized by the eyesight sensor and is not recognized by the peripheral sensing acquisition section, wherein the display controller may control displaying the icon of the object as a second form when the object is not recognized by the eyesight sensor and is recognized by the peripheral sensing acquisition section, and wherein the display controller may control displaying the icon of the object as a third form when the object is recognized by both the eyesight sensor and the peripheral sensing acquisition section, the first form, the second form and the third form being different from each other.

Thereby, an icon is displayed as object information, and it is enabled to change the display mode of the icon whether the object was recognized in each of eyesight sensing and/or peripheral sensing.

Also, in one aspect of the invention, the display controller may select a single object from the object comprising two or more candidate objects based on at least one of the eyesight sensor and the peripheral sensing acquisition section and controls displaying of the object information of the single selected object.

Thereby, using at least one of eyesight sensing information and peripheral sensing information, it is enabled to select one object as a display object from a candidate object.

Also, in one aspect of the invention, the display controller may select the single object determined by at least one of a) a distance from the wearer being nearer than a distance of other candidate objects and b) an angle from a front direction of the wearer being smaller than an angle from the front direction of the wearer of other candidate objects and controls displaying the object information of the object selected based on at least one of the eyesight sensing information and the peripheral sensing information.

Thereby, eyesight sensing information is acquired by imaging and peripheral sensing information is acquired based on a signal strength, and it is enabled to select one object from candidate object(s) with the proviso that having been done sensing in both eyesight sensing and peripheral sensing and the angle to the eyes direction are smaller than other objects.

Also, in one aspect of the invention, the display controller may select the single object determined by a distance from the wearer being nearer than a distance of other candidate objects based on at least one of the eyesight sensing information and the peripheral sensing information.

Also, in one aspect of the invention, the display controller may select the single object determined by an angle from a front direction of the wearer being smaller than that of other candidate objects based on at least one of the eyesight sensing information and the peripheral sensing information.

Also, in one aspect of the invention, the display controller may control displaying property information of the object as the object information. Thereby, it is enabled to display the property information of the object as object information.

Also, in one aspect of the invention, when a number of the at least one candidate object is equal or more than a predetermined threshold value, the at least one candidate object being divided into a first group and a second group, wherein the display controller may control displaying the object information in the first group, a number of the first group being less than the predetermined threshold value and wherein the display controller may control displaying a indication of a number of the second group.

Thereby, the number of object information to be targeted for display is limited, and it is enabled to notify the wearer of the number of the object(s) which did not become targeted for display to the wearer.

According to another embodiment of the invention, there is provided when a number of the at least one candidate object is equal or more than a predetermined threshold value, the at least one candidate object being divided into a first group and a second group, wherein the display controller may control displaying the object information in the first group, a number of the first group being less than the predetermined threshold value and wherein the display controller may control displaying an indication of a number of the second group.

According to another embodiment of the invention, there is provided a computer program product storing a program code that, when executed by a computer, implements control of: an eyesight sensor to acquire eyesight sensing information by eyesight sensing in a field of view of the eyesight sensor, a peripheral sensing acquisition section to acquire peripheral sensing information by a peripheral sensing having a detection angle larger than an angle of the field of view of the eyesight sensor, and a display controller to control displaying object information of an object in the image, the object being selected from at least one candidate object recognized by at least one of the eyesight sensor and the peripheral sensing acquisition section.

According to another embodiment of the invention, there is provided a display controlling method of a wearable device configured to be worn by a wearer, wherein the wearable device has a display to provide an image on a display area that occupies a part of a field of view of the wearer, the method comprising: acquiring eyesight sensing information by eyesight sensing in a field of view of the eyesight sensing, acquiring a peripheral sensing information by peripheral sensing having a detection angle larger than an angle of the field of view of the eyesight sensing, and controlling displaying object information of an object in the image, the object being selected from at least one candidate object recognized by at least one of the eyesight sensing and the peripheral sensing.

Various embodiments of the invention are described below. Note that the following embodiments do not in any way limit the scope of the invention laid out in the claims. Note also that all of the elements of the following embodiments should not necessarily be taken as essential elements of the invention.

### 1. Technique of the Present Embodiment

At first, a technique of the present embodiment is described. As mentioned earlier, under the world view of “Internet of Things”, every “thing” placed in the daily environment has information and is networked. And each “thing” (in the following, described as an object because it is targeted for recognizing and acquiring information) sends its information on a network, and the user acquires the information and reads it.

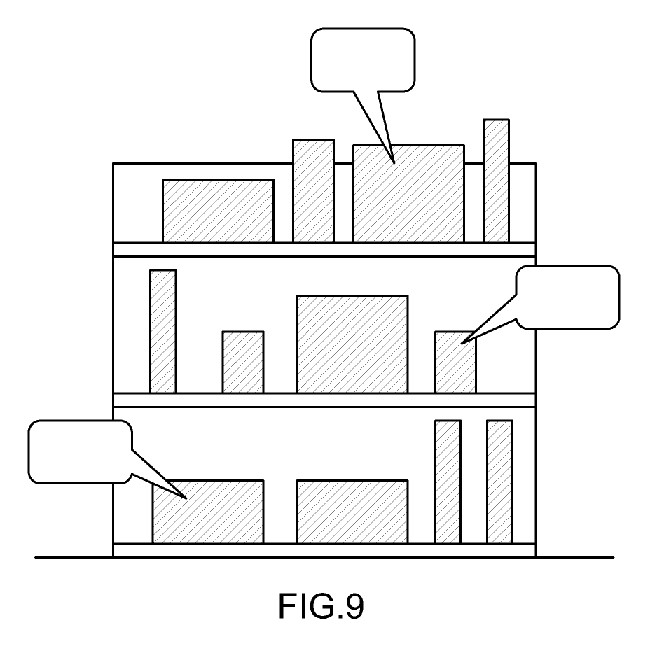

Various things, such as, for example, the smart home electrical appliance, the garden plant and water tank (which are not electronic devices) and various kinds of products exhibited on a product shelf as shown in FIG. 9 may be applicable as a candidate of the objects described herein. The outgoing form of the information may be provided in various ways—for example, each home electrical appliance may use SNS (Social Networking Service). One example is that the information included in it is broadcasted to a user by using short sentence contribution service. More specifically, the owner of a refrigerator, for example, may be informed of quantity or the state of preservation of the food that a refrigerator has inside. Note that the balloons in the example of FIG. 9 expressed the world view of “Internet of Things” where each product sent information. Thus, the information presentation may be really performed in the form of the balloon using augmented reality to a user, but the present embodiment is not limited to such a technique.

Also, about the things which themselves such as, for example, a garden plant or a water tank, do not originally have electronic devices or communication facility, small size electronic devices comprising a sensor and the communication section may be attached to such things. In another example, the information of the object may be managed with servers and the apparatus which a user (e.g. the manager of the garden plant, the buyer of the product) recognizes as an object and may request the information acquisition to a server.

Under this world view, if all the enormous information on the network was acquired, such information would include unprofitable information. Also It is not realistic because the amount of the information is so large. Thus, it may be thought that the sensing processing may use some kind of sensors, acquiring the information of the sensed object and displaying it.

One embodiment of this invention may use peripheral sensing (such as, for example, sensing the object(s) around the user) together with eyesight sensing (such as, for example, detecting the object(s) in the eyes' direction. According to this configuration, sensing can be done about the apparatus which does not exist in the view direction of the wearer or the apparatus which cannot be seen directly by the wearer or sensing can be done about the object which cannot transmit electric wave.

However, when two sensing techniques are used together, it may be considered how to show a sensing result to the user or how to control display controlling in the display area specifically. In this embodiment, a wearable device (e.g., Head Mounted Display, HMD) having the display area of the see-through type is assumed as the apparatus which a user uses. Therefore the user here becomes a wearer putting on a wearable device. The reason why the wearable device of the see-through type is assumed, in this example, is that it is convenient for the user in the eyesight sensing.

When the object side sends information actively (e.g., an object is electronic device), it is useful information to judge whether the object is in the front of a user or not as described in the following. The see-through type wearable device including the eyesight sensor that senses the front direction (in a narrow sense eyes direction) of the user has high affinity with the technique of the present embodiment.

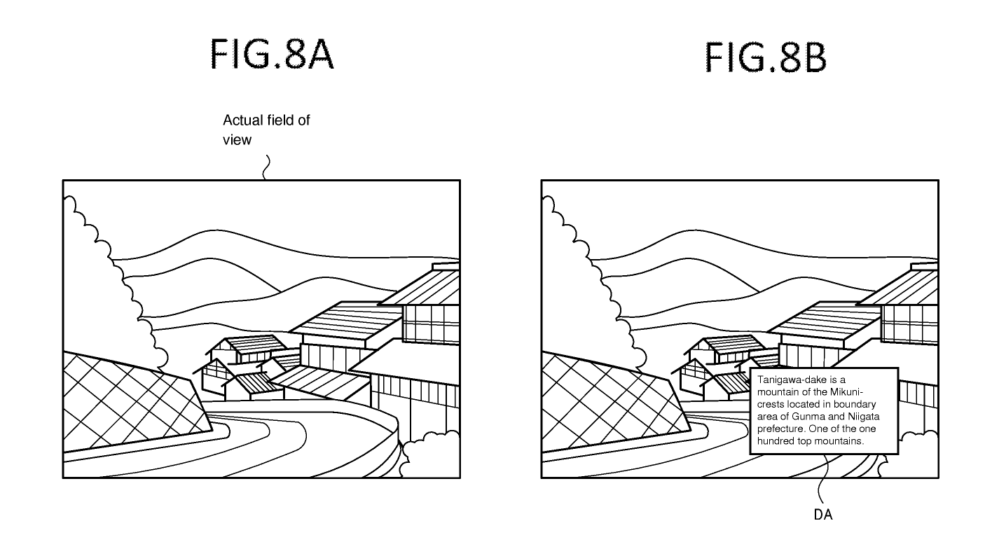

That is, convenience can be improved by using a see-through type wearable device, but the narrowness of the display may sometimes become a concern in the wearable device. In that case, it may be preferred to examine a technique of the controlling display as described. That is because when a user moves while wearing the see-through type wearable device, it is difficult to equip a large sized information displaying area which may cause the user to hardly recognize an outside world view. Thus, when, for example, the view (real field) of the user is a state as shown in FIG. 8A, the display area obscures a section of the outside world view as shown in DA of FIG. 8B, and, as a result, the area of the display is limited.

If the area of the display is limited, the information that can be displayed at a given time decreases. But the recognizable objects are increased by using both eyesight sensing and peripheral sensing together as described. That is, it may be necessary to display the information of the object (sometimes called object information) in an appropriate embodiment about the object that it is assumed to be detected a lot of times.

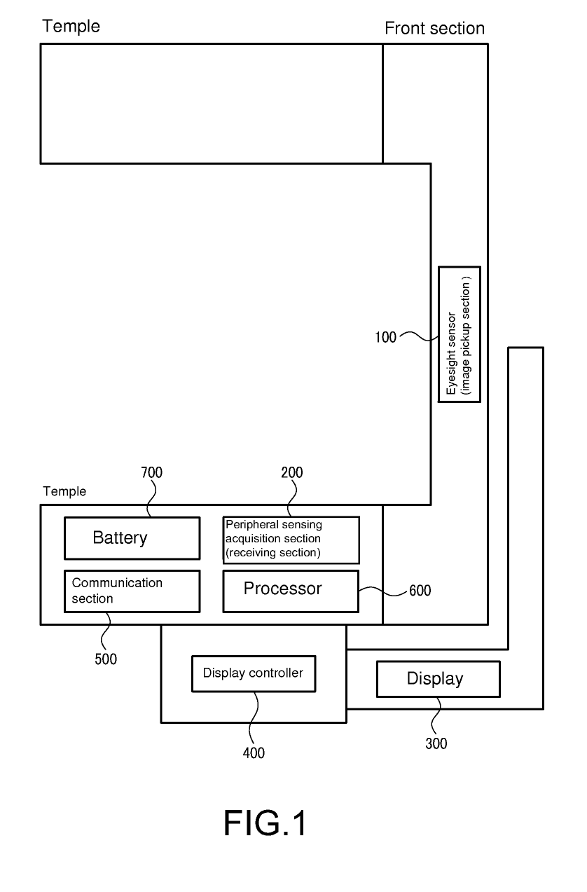

One embodiment is a see-through type wearable device to suitably display the object information of the detected object by using peripheral sensing together with eyesight sensing. Specifically, as shown in FIG. 1, one example of this embodiment relates to a wearable device comprising a display 300 configured to display an image on a display area that occupies a part of an eyesight of a wearer, an eyesight sensor 100 configured to acquire eyesight sensing information by an eyesight sensing of an object directed to the eyesight of the wearer, a peripheral sensing acquisition section 200 configured to acquire peripheral sensing information by a peripheral sensing of the objection around the wearer and a display controller 400 configured to control displaying an object information of a object on the display, the object being selected from candidate objects that are recognized by at least one of the eyesight sensing and the peripheral sensing.

A system constitution example of the wearable device of the present embodiment is shown in FIG. 1. FIG. 1 is a figure which shows a glass type wearable device (HMD) from the upper section. A temple section is an ear cover section and the front section is the section where it is provided with a lens in a normal eyeglasses. Note that the wearable device of the present embodiment is not limited to glass type. As shown in FIG. 1, the wearable device includes the eyesight sensor 100 and the peripheral sensing acquisition section 200 and the display 300 and the display controller 400 and the communication section 500 and processing section (processor) 600 and battery 700. However, the wearable device is not limited to the constitution of FIG. 1 and omission of some composition elements and various kinds of transformative implementations such as, for example, adding other composition elements is possible.

The eyesight sensor 100 performs the eyesight sensing that senses an object in the view of the user. The peripheral sensing acquisition section 200 acquires a result of the peripheral sensing that senses an object around the user as peripheral sensing information. It is described below for more information about the eyesight sensor 100 and the peripheral sensing acquisition section 200. Note that the wearable device may include the peripheral sensing acquisition section 200 which may be a peripheral sensor performing peripheral sensing (in order to acquire the result of the peripheral sensing by itself) and/or the peripheral sensing acquisition section 200 may acquire the result of peripheral sensing implemented by one or more other apparatuses.

The display 300 superposes a display image on the outside world view of the user display. As an example, as shown in FIG. 1, a frame whose tip comes to the position of the eyeball front of the user may be provided and the display 300 may be provided on the tip of the frame. The display controller 400 performs display controlling with the display 300. Note that the display controller 400 of the present embodiment shall perform not only controlling operation of the display 300 but also generation processing of display images displayed on the display 300.

The communication section 500 performs communicating with other electronic devices through a network. Specifically, the communication section 500 receives the object information from an object and transmits a control signal based on a user operation to an object with the control screen described as follows.

The processor 600 takes various kinds of steps based on operation information by the user operation or the information that the communication section 500 received. The function of this the processor 600 can be implemented by hardware and/or programs such as various processors (e.g., CPU), an ASIC (e.g., gate array). Note that it is assumed to be performed in the display controller 400 about the processing which is necessary for display controlling of the display 300 as described.

Battery 700 provides electricity to operate each section of the wearable device.

From here on, after describing an embodiment of eyesight sensing and peripheral sensing, it is described in detail about display controlling carried out in the present embodiment. As an example of display controlling and selection processing to select one or a plurality of objects from one or more candidate objects (including not only simple selection but also setting processing of priority information) is descried about displaying an icon, or controlling screen.

### 2. Eyesight Sensing and Peripheral Sensing

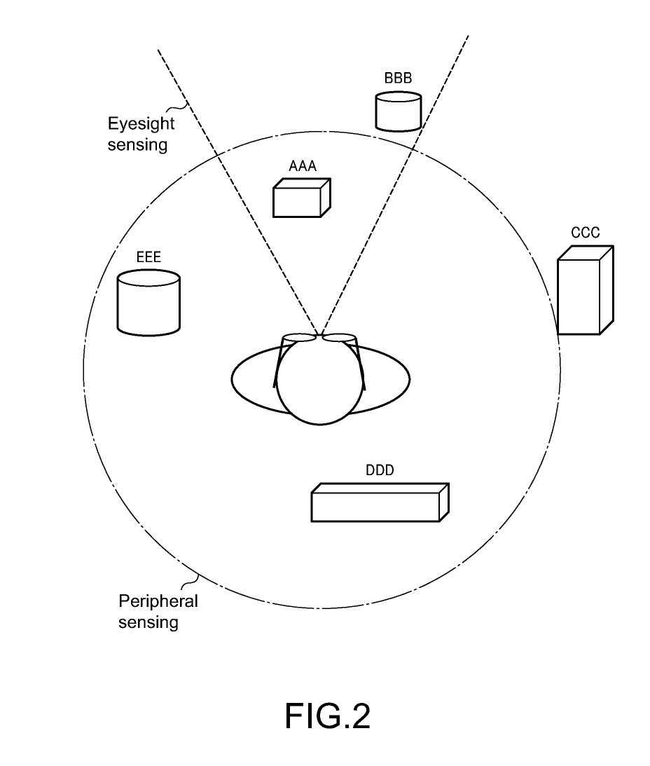

An embodiment of eyesight sensing and peripheral sensing is described. Note that eyesight sensing and peripheral sensing are not limited to that described below. FIG. 2 illustrates an example of an area of the eyesight sensing corresponding to a field of view of the eyesight sensing and an example of an area of the peripheral sensing corresponding to a vicinity of the wearer. The area of the eyesight sensing has a predetermined detection distance from the wearer and a predetermined detection angle which includes a direction forward from the face of the wearer and narrower than a whole circumference. The area of the peripheral sensing has a detection distance from the wearer (e.g. depending upon the strength of the signal from the object) and a predetermined detection angle broader than that of the field of view of the eyesight sensing. In addition, if the object in the area corresponding to the field of view of the wearer can be recognized as shown in FIG. 2, other techniques may be used as an alternative of eyesight sensing. And other techniques may be used as alternative of the peripheral sensing if the object around the wearer can be recognized as shown in FIG. 2.

### 2.1 An Embodiment of Eyesight Sensing

An example of the eyesight sensing may use an imager as shown in FIG. 1. And it is considered to perform image processing of a pickup image acquired by the imager. As for the technique to detect an object from a pickup image, it is conceivable in various ways, but, for example, template information may be maintained for every object and a template matching process may be performed using the template information matched to a pickup image. Alternatively, an amount of characteristic information of the object is memorized and it may be performed to compare between an amount of characteristic information from a pickup image and the memorized object information. Here, the amount of characteristic may be a pixel value (e.g. a value of R, G, B) and may be brightness and a color difference(Y, Cr, Cb) and may be other values acquired from them. Also, the space frequency properties acquired by performing Fourier transforms may be the amount of characteristic.

Here, the angle of view (subject range targeted for the imaging of the imager) of the imager does not necessarily correspond with the angle of view of the real field of view of the wearer. As mentioned earlier, it is preferred that an angle of view of the imager and the angle of view of the user have corresponding relationship if it is assumed that a sensing is performed by the movement of what a wearer turns to the direction of the object. However, considering that the individual difference in a wearing state or the wearing gap when the wearer is in a state of walking, it is difficult to require that they are corresponding to each other closely. And the intended processing is possible even if they are not corresponding to each other closely. Also, if a supposition such that the eyes direction of the user concentrates on a central portion of the view is used (e.g., only moving eyes is not considered), it is enough to acuire the pickup image having an area corresponding with the central portion of the user field of vision. Alternatively, in consideration of the gap between eyes' direction of the user and the optical axis of the imager, it can be possible to acquire the pickup image of the angle of view that is wider than a field of view of the user. That is, various kinds of deformational implementation of the imaging range by the imager are possible, and the present embodiment can apply them widely.

Alternatively, if the object can be provided with a light-emitting unit for irradiating infrared light or visible light or can be attached to an electronic device having the light emitting portion, the eyesight sensing can be also implemented by a light receiving portion (receiver) for receiving light from the light emitting portion (emitter). In this case, it is not necessary to get for the eyesight sensor to the pickup image as the imaging unit, and it is enough for the eyesight sensor to provide with the configuration that can recognize light emitted from the object. Thereby, eyesight sensor is easily constituted at low cost because the light emitting portion itself is low cost.

### 2.2 An Embodiment of Peripheral Sensing

Next an example of an embodiment of the peripheral sensing is described. About the peripheral sensing, it is assumed that some kinds of signals are output from the object side unlike the eyesight sensing. That is, about the object which is not electronic devices and cannot be attached with an apparatus for signal outputting it cannot be recognized even if it was close to the wearer.

For an example of the peripheral sensing, it may be accepted to detect an electric wave of wireless LAN such as the Wi-Fi that the object outputs for communication. As mentioned earlier, it is common for the object of the present embodiment to have a communication section because it is assumed that electronic devices output the information acquired by using sensors of them. When a signal for such a communication can be detected, the object which outputs a signal can be judged to be around the wearable device. Also, the signal becomes stronger when the distance of the object is nearer to the wearable device and becomes weaker when the distance to the object is further. That is, the distance from wearable device to an object can be also estimated as well as the presence or absence of object by using simply signal strength. Also, it can be estimated at which direction an object exists relative to a wearable device because the direction of the origin of signal outputs can be estimated to some extent. Thus, as shown in FIG. 2, it can be estimated the relative positional relationship between the object and the wearable device based on signal strength and a signal direction. However, these signals which are detected by the wearable device include not only a signal arriving at the wearable device directly but also a signal reflected back by other objects. Thus, when it is used for processing the signal direction, it should be noted that the process may be adapted to the process having no large problem with not high accuracy or including correction processing for increasing the accuracy by considering the presence of the reflected wave.

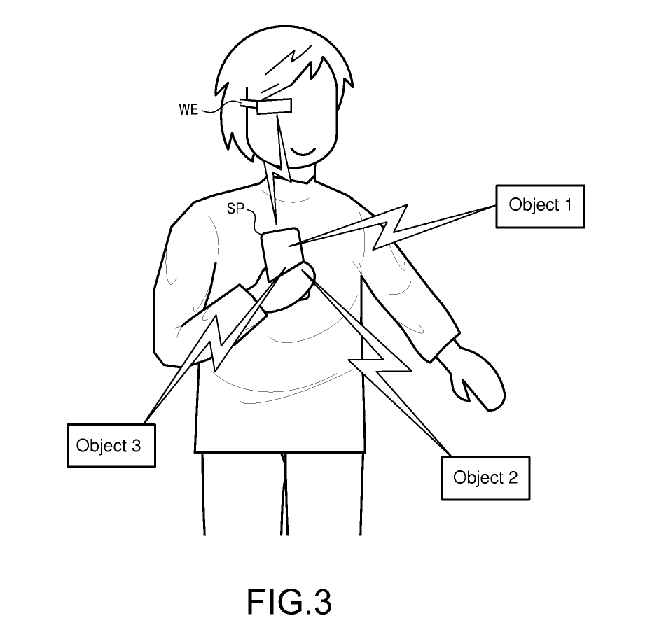

Also, the case that the wearable device does not exchange direct signals with an object can be considered. For example, wearable device WE and cell-phone SP are connected by short-range radio (e.g., BLUETOOTH (registered trademark) not limited to this) as shown in FIG. 3, and it is conceivable when cell-phone SP is connected to networks such as one or more an objects or the Internet. In this case, the peripheral sensing is performed by cell-phone SP, and wearable device WE will acquire from cell-phone SP the peripheral sensing information that is a result of the peripheral sensing.

Alternatively, it is considered that the wearable device (or the cell-phone which the user of the wearable device holds) and an object have a location information acquisition section such as the GPS, respectively and they transmit acquired location information to the location information management server on a network. In this case, the wearable device and an object are not interconnected, but because the position of the wearable device and the position of the object can be grasped with the location information management server, an object existing around wearable device can be identified. This is processing of the peripheral sensing. In this case, the wearable device itself does not perform peripheral sensing but acquires the peripheral sensing information that is a result of the peripheral sensing from the outside.

### 3. Display Controlling

An embodiment of the display control to be carried out in the display controller 400 is described. At first, the selection processing from a candidate object is described, then an example displaying a control screen and displaying an icon as an embodiment of the object information are described.

### 3.1 Candidate Objects and Selection Processing

In this embodiment, peripheral sensing is used together with eyesight sensing as described. Thus, because the information of an object recognized by at least one of eyesight sensing and peripheral sensing can be acquired, it can be with a candidate of the display with the display 300. Thus it is decided to refer to an object recognized by at least one of eyesight sensing and peripheral sensing as a candidate object in the present embodiment.

As described above, because it is assumed that the candidate object is some number, it may lead to be difficult to display the object information of all candidate objects on the display 300 of the see-through type wearable device or may become difficult for the wearer to understand the information because of displaying all object information with an equal priority.

Thus, in the present embodiment, selection processing to a candidate object is performed to decide display controlling of the display 300 as display mode based on the result of the selection processing. Selection processing here may be processing to select one object from one or more candidate objects and may be processing to select a plurality of objects from one or more candidate objects. Because the whole display can be used for display of the object information of one selected object when one is selected, a more detailed information presentation is enabled. However, about the candidate object which was not selected, even though it is recognized by at least one of eyesight sensing and peripheral sensing, information of it cannot be shown. Thus, it may be assumed that the object information of more objects is displayed by selecting a plurality of objects from one or more candidate objects.

Here, it is conceivable to use the peripheral sensing information that is a result of the peripheral sensing and the eyesight sensing information that is a result of the eyesight sensing for selection processing. For example, a candidate object includes three kinds of an object: (a) an object recognized by only eyesight sensing, (b) an object recognized by only peripheral sensing, and (c) an object recognized by both eyesight sensing and the peripheral sensing, But it may be preferentially displayed about the object recognized by both eyesight sensing and peripheral sensing. In an example of FIG. 2, among objects AAA-EEE placed in the environment, AAA, BBB, DDD, EEE are recognizable candidate objects. The AAA is recognized by both eyesight sensing and peripheral sensing, the BBB is recognized only by eyesight sensing and DDD and EEE are recognized only by peripheral sensing. In this case, understanding from FIG. 2, the AAA is located in the front direction of the user and is near to the user, the BBB is located in the front direction of the user and is further from the user than AAA. DDD and EEE are near to the user but located in the side or the back of the user. That is, the object recognized by both eyesight sensing and peripheral sensing like AAA should be selected in the selection processing with precedence because it is assumed that the interest degree of the user is high.

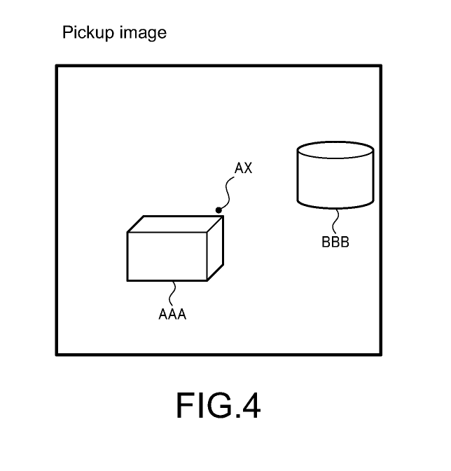

Also, in the eyesight sensing, the angle information to the front direction of the user can be acquired. For example, in the example using the captured image, pixels corresponding to the optical axis of the imager are information known from the design of the imager. For example, a pixel at the center of the captured image is known. Therefore, by comparing the pixel corresponding to the optical axis and the position on the image of the object that was recognized, it becomes possible to know the angle of the object relative to the optical axis. For example, the pickup image acquired in the case of eyesight sensing of FIG. 2 becomes like FIG. 4. It is revealed that the AAA has an angle from the optical axis direction (AX) that is small and the angle of BBB from the optical axis direction (AX) is larger than that of AAA, by comparing positions of pixel AX corresponding to the optical axis on the pickup image, the object AAA and the object BBB on the pickup image. When angle information is acquired, it is assumed that the interest degree of the user is high about the things which have a position near to the optical axis direction, so it should be done that selection processing selects such a candidate object with precedence. Note that the mentioned explanation premised that the optical axis direction of the imager and the eyes direction of the wearer had correspondence relationship to some extent. Thus, if the optical axis direction of the imager and the eyes direction of the wearer are greatly different directions and the pixel on the pickup image corresponding to the eyes direction is predetermined, the angle information may be processed based on the eyes direction pixel.

Note that the distance information to an object can be acquired based on a pickup image if the imager has a constitution that stereo matching is possible. In that case, selection processing may be performed to preferentially select the candidate object having a distance from a user that is closer (shorter).

Also, in the peripheral sensing, the distance information between a user and the candidate object can be acquired by using signal strengths as described. In this case, selection processing to preferentially select the candidate object which the distance from a user is close to should be performed. Also, the direction of the object can be estimated from the electric wave direction as described above. In this case, selection processing to select a candidate object located in the direction that is near to the front direction of the user (in a narrow sense eyes direction) with precedence should be performed. However, an error to be caused by signals reflected back by other objects can be produced in the estimated processing using the signal direction as described. Thus, it may be more preferred to perform correction processing which prevents error generation or to use an angle information acquired by the eyesight sensing information when the candidate object is recognized by both the eyesight sensing and the peripheral sensing.

Selection processing may be performed by using information whether it was recognized by eyesight sensing or peripheral sensing, or both eyesight sensing and peripheral sensing, the direction or the distance of the object from the user as the basis. As an example, as for the scores for the object that is to be preferentially selected in the above description, it can be performed to provide a score higher than that of the other object(s) and the selection processing can be carried out in terms of various points using the results of the scoring. Also in this case, it can be thought as some methods to select the highest scoring k pieces, wherein the number k (k is an integer of 1 or more) were selected in advance or to select everything to be displayed whose score is greater than Th, wherein Th was set in advance as the threshold of the score. Also, as other example, the display controller 400 may select the single object determined by at least one of a) a distance from the wearer being nearer than a distance of other candidate objects and b) an angle from a front direction of the wearer being smaller than an angle from the front direction of the wearer of other candidate objects. And the display controller 400 controls displaying the object information of the object selected based on at least one of the eyesight sensing information and the peripheral sensing information.

Also, they may be displayed equally when a plurality of objects are selected from candidate objects as displaying object. It can be also possible to change display modes of the plurality of objects based on the priority which is set. The technique like the mentioned scoring can be applicable to the setting of the priority of this case.

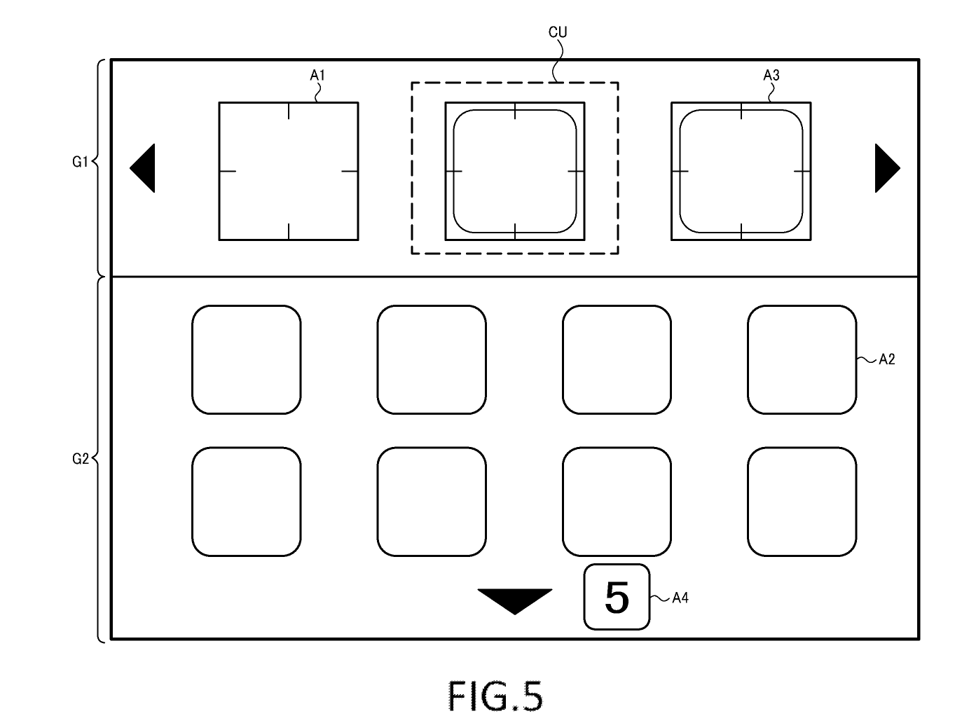

Although the priority of a selected plurality of objects as a displaying object are not set, it may be worked to classify them in a plurality of groups and display modes may be changed in each group. For example, selected k objects are classified in group 1 and group 2, and the object(s) classified in group 1 displays in the first display mode, and the other object(s) classified in group 2 displays in the second display mode. For example, a classification is conceivable that an object recognized in eyesight sensing is group 1 and an object recognized in peripheral sensing, is group 2. The display mode may refer to the placement position of the icon in the display to be described below using the example of the icon in FIG. 5. The display mode may also represent the shape or size of the icon, and so on. In this case, it does not need to provide any difference of the priority on the target objects which are considered to be in the same group. Also it does not need to provide any difference of the priority between those groups.

Alternatively, both group classification and priority setting may be performed. Specifically, a priority may be set for the target objects in the group so as to perform ranking, a priority is provided between some groups such that an object of group 1 are displayed larger at the position that is more easy to be watched than an object of group

Also, it may be applicable to use different points of view between a processing to select a displaying object and a processing to resolve a priority for the selected display object. For example, in the selection of the display object, it is displayed about an object recognized by both eyesight sensing and peripheral sensing and is not displayed about an object recognized by only one sensing in that case. In this case, it is not a criterion that the angle is close to the front direction of the user or the distance between the user and the object is close. And in case of setting the priority of the object selected for displaying, it can be possible that a processing of the setting is performed based on an angle to the front direction or a distance to the user.

Note that “selection processing” of the present embodiment includes the selection processing of the narrow sense to select an object targeted for the display of the k object from a plurality of candidate objects, priority setting processing and group classification processing. And selection processing does not have to perform all of the selection processing of narrow sense, priority setting and the group classification processing. It may perform, for example, one of them or a combination of two of them. That is, the selection processing of present embodiment has a concept including a processing of skipping the selection processing of narrow sense and to perform only priority setting processing or group classification processing. For example, in the case there are sufficiently small numbers of recognized candidate objects, all the candidate objects can be displayed. In this case, the selection processing of the narrow sense is skipped.

### 3.2 Icon Display

A description is now made of an example displaying an icon as object information. The information from an object is considered in various ways. For example, when electronic devices are recognized, information such as the names of the electronic devices, model numbers, makers, power consumption and the current movement situation are acquired. It can also acquire, for example, information such as quantity or the freshness of food in a refrigerator. Also, for example, information of temperature and the fluid volume included in the soil can be acquired by a sensor in the example of the garden plant. Because the amount of the detailed information that an object may notify to a user (as follows, detailed information) are fundamentally large, it is difficult to display the detailed information from a plurality of objects considering the area of the display 300. And it may rather disturb the understanding of the user if a large amount of information is displayed at one time.

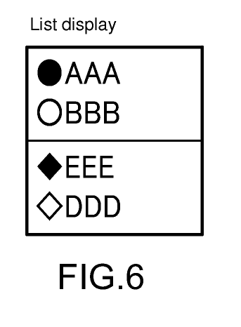

Thus, in one example, detailed information is not displayed from the beginning. At first a candidate object or an icon representing a selected object by selection processing in a narrow sense from there is displayed. Because it is desirable for a user to be able to identify the candidate object when the user sees the corresponding icon, it is conceivable to use a pattern diagram that, for example, may use a figure representing what an object is. However, the icon is not limited to a pattern diagram and is feasible by various kinds of forms. Note that while it is not described in detail here, it may be possible to use a list of the texts such as the names of the object as shown in FIG. 6 instead of the icon.

As seen in FIG. 5, examples of the display control corresponding to each of the selection processing of narrow sense, group classification processing and the priority setting processing are described. When the selection processing of narrow sense is carried out, the objects which does not become target for displaying comes out for the candidate object. In that case, the icon of the selected object by the selection processing of narrow sense is simply displayed and it may be possible that information about the object which is not selected may not be displayed at all.

However, as for the object which was not selected, if a user expects, it can be possible to acquire information from the object because the position of the object is near enough for using sensing even if there are some kind of reasons that the object is not selected. Those reasons are, for example, the distance from the user is relatively big or the angle from the eyes direction is large. That is, even if the individual information of the object which was not selected is not displayed, it is useful for notifying the existence of the object which is sensed and is non-display. Thus, for one example, the number of a candidate objects assumed non-display may be displayed as shown in A4 of FIG. 5. In this case, to control displaying the object information (e.g., an icon) of the object may be performed when it was performed by a user to operate displaying the information of an object becoming the non-display.

Also, FIG. 5 shows an example of performing the group classification processing. Specifically, after having classified objects wherein an object recognized by eyesight sensing is classified in group 1 and an object not recognized by eyesight sensing but is recognized by peripheral sensing is classified in group 2, displaying is controlled so that group 1 is illustrated in G1 of FIG. 5 as displayed in the upper section of the display and that group 2 is illustrated in G2 of FIG. 5 as displayed in the lower section of the display. Also, in the display mode, not only the display location but also the frame shape of the icon is differentiated. For example, group1 is illustrated by the square-shaped frame as shown in A1 and group 2 is illustrated by the frame of a rounded corner as shown in A2.

Furthermore, in the example of FIG. 5, group 1 is subdivided in group 1-1 which are recognized in both eyesight sensing and peripheral sensing, and group 1-2 which is not recognized in the peripheral sensing and but recognized in the eyesight sensing. And, in FIG. 5, there are different embodiments as follows. Group 1-1 displays double both square-shaped frame and a frame whose corner are rounded as shown in A3 and group 1-2 provides embodiment to display only the square-shaped frame as shown in A1.

Also, in FIG. 5, the priority that is higher than group 2 is set to group 1 and, as a result of that, the icons included in group 1 (e.g., A1 and A3) are displayed larger than the icons included in group 2 (e.g. A2). Herein, the priority setting processing in the group is not considered, but, for example, it may possible that priority setting is processed in group 1 and the thing with the high priority is displayed in the center.

Note that it was not described in the explanation of the selection processing in detail, but, for example, it becomes possible that after having group classification processing and priority setting, the selection process of the narrow sense using the result of them is performed. In an example of FIG. 5, it was performed beforehand to set display three icons as group 1 and to display eight icons as group 2. After that, it may process the selection of the narrow sense to respectively select three objects with the high priority among objects included in group 1 and eight objects with the high priority among objects included in group 2 using a result of group classification processing and the priority setting processing. In that case, because it has a possibility that the candidate object is not selected by the selection processing of narrow sense in every group, the number of the object(s) which is non-displayed in every group may be displayed though it is non-displayed in FIG. 5. For example, the number of the candidate object(s) classified in group 1 and non-displayed may be displayed in the upper section (G1) of the display and the number of the candidate object(s) classified in group 2 and non-displayed may be displayed in the lower section (G2) of the display.

### 3.3 Display of the Control Screen

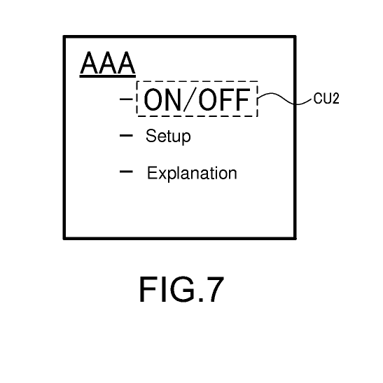

A description is now made of an example displaying a control screen used for the control of the object as object information. This assumes the case that the object is an electronic device. For example, a control screen is a screen which is shown in FIG. 7 and is a screen for performing the ON/OFF control of the electronic device which is an object (AAA in an example of FIG. 7) and a screen for controlling various settings. The setting subject matter varies according to the classification of electronic devices. For example, if an object is television, it may be a change of a channel and the volume, the setting of the receiver channel. And if it is an air-conditioner, it may be a performance mode such as the air conditioner heating or cooling and setting of temperature or the wind quantity. This example shows treatment of a wearable device as a wireless remote controller operating an object.

Note that selection and the decision processing of items displayed by a control screen may be performed by an operating section (e.g., operation buttons) with which a wearable device is provided. For example, as shown in CU2 of FIG. 7, the item which is in selection state is shown by cursors to a user, and the user makes a desired item to be in a selection state while looking at the position of the cursor. And the control corresponding to the item which was in selection state may be performed when decision operation is carried out. However, if long-time wearing is considered, as for the wearable device, it is desirable to be small and light. In this case, it is possible that the operating section cannot be included in the wearable device. Thus, it may be performed to select and decide processing by the sensors with which the wearable device is provided. For example, the neck swing movement of the user can be detected by using an acceleration sensor and a direction sensor (e.g., a geomagnetic sensor). Thus, selection and decision processing can be performed by combining a lateral (sideways) neck swing with an up and down neck swing. If it is the example that a menu item forms a line in lengthwise direction like FIG. 7, a selection item (cursor position) is moved by a neck swing in the top and bottom direction. And decision processing may be performed so that the item comes into execution state from the selected state by doing a lateral (sideways) neck swing in the conditions where a predetermined item was selected. However, various kinds of sensors can be put on the wearable device and the operation in the control screen may be implemented by other sensors. For example, if the imager to image the eyeball of the user is included in the wearable device, the direction of the eyes of the user can be detected. Thereby, selection and decision process using the change of the eyes direction is enabled.

Here, in this example, if size of the display 300 is considered, it is not appropriate to display the control screens corresponding to a plurality of objects at the same time because the control screen can include much display items like examples of the-mentioned detailed information. Also, the possibility of an erroneous operation should be inhibited because the operation which uses the control screen transmits a control signal to other electronic devices for real. It should also avoid displaying too many control screens at the same time.

Thus, in this example, it is preferred to be narrowed down to a small number of objects (in a narrow sense one) for displaying when a control screen is displayed. Here, as for the decision technique of an object displaying a control screen, it is conceivable in various ways. For example, as shown in FIG. 5, it is conceivable that the existence of a plurality of candidate objects is shown by using icons and one icon is selected from them by the operation of the user and the control screen of the selected object is displayed. In this case, in one example, it may be preferred to perform controlling such as displaying a cursor to the icon which is in selection state like CU2 in FIG. 7. Note that an object may include electronic devices controllable by the wearable device and/or an uncontrollable object like a product exhibited on a shelf as described above. Thus, it may occur that the user attempts to select to operate the icon corresponding to the object which is not controllable. This may lead to undesirable confusion of a user.

Thus, in selection processing (selection processing of narrow sense, group classification processing and priority setting processing), the processing may be performed based on the point of view whether a candidate object is controllable. For example, even if the wearable device side understands that a user expects the display of the control screen, a controllable object may be selected in the selection processing of the narrow sense, and the uncontrollable object may not be selected. Alternatively, in group classification processing, a controllable group and an uncontrollable group may be made and a display mode may be changed for each group. For example, when icons are displayed like FIG. 5, it can be considered that the icon of a controllable object is surrounded by a predetermined colored frame and the icon of an uncontrollable object is not surrounded in the predetermined colored frame.

Also, it may be assumed that a user goes near to the electronic devices and operates the electronic devices by turning toward the direction of the electronic devices when the user operates the electronic devices. Considering this situation, it may be assumed as especially important indexes for displaying the control screen that those electronic devices are near to a user and/or the angle between direction of the electronic devices and the eyes direction of the user is small. Conversely it may be less likely for a user to operate an object at an angle far from the eyes direction even if the object is at a position that is near to a user or to operate a far-off object even if the angle with the eyes direction is small.

Considering this point, it becomes possible that the selection operation of the controlled object by the user is not accepted and the automatic selection of a control object is performed in the wearable device side after displaying icons. Specifically, it may be an automatic selection of the single object whose position is near to a user and whose angle with the eyes direction of the user is small and displays the control screen of the object as described above. Thereby, the control screen can be displayed without forcing complicated operation on a user.

Alternatively, the object of a candidate displaying the control screen may be selected automatically, and the result may be shown. For example, when an icon is displayed, it is assumed that a candidate for controlling acquired by automatic selection became in a selection state and then, a cursor representing a selection state (e.g., CU of FIG. 5) is displayed on the icon of the object. According to this configuration, because a user can do decision operation without performing cursor movement when a result of the automatic selection is right, complexity of the operation can be inhibited. Furthermore, when automatic selection does not follow what the user intended, it can give the opportunity of correction to the user.

### 4. Present Embodiment

In the present embodiment as shown in FIG. 1, the wearable device includes a display 300 to provide an image on a display area that occupies a part of a field of view of the wearer, an eyesight sensor 100 to acquire eyesight sensing information by an eyesight sensing in a field of view of the eyesight sensor, a peripheral sensing acquisition section 200 to acquire peripheral sensing information by a peripheral sensing having a detection angle larger than an angle of the field of view of the eyesight sensor, and a display controller 400 to control displaying object information of an object in the image, the object being selected from at least one candidate object recognized by at least one of the eyesight sensor and the peripheral sensing acquisition section.

The wearable device may set a part of the view of the wearer as a display area. Here, when the field of view of the wearer (eyesight) is assumed as an area as shown in FIG. 8A, FIG. 8B, the definition of the “that display area is set on a part of the area in the field of view of the wearer and an image is displayed on the display area” is the state that the image is displayed on a part of the area and the wearer can recognize the outside world about the area which is not a display area in the view of the user. The image may be, for example, an enlarged virtual image. Enlarging the image can be achieved, for example, by an optical system included in the display 300.

Thereby, it becomes possible to suitably recognize an object which cannot be recognized by merely the eyesight sensing or the peripheral sensing, the object in which sensors are not incorporated or the object which enters the blind spot of imaging. Furthermore, by displaying the object information of the selected object from recognized candidate objects, it becomes possible to inhibit that the amount of the displaying information is superabundant, to inhibit lowering of legibility of each information and to show the information on which a user has a strong interest.

Also, the display controller 400 may perform to control displaying the object information of the object with precedence, for example, to object(s) recognized by eyesight sensing and by peripheral sensing among candidate objects.

Thereby, it becomes possible to preferentially display an object recognized in both eyesight sensing and peripheral sensing among candidate objects. Because the object is placed in the front direction of a user and in the near distance from the user, as shown in FIG. 2, the user is more likely to be interested in the object recognized in both eyesight sensing and peripheral sensing. Thus, it is enabled to raise the possibility to display the information that a user expects by preferential displaying of the object.

Also, the display controller 400 may perform to control displaying the control screen used for the control instructions to the object as object information. Furthermore, the wearable device of this example, includes the communication section 500 communicating with the electronic device(s) which are an object as shown in FIG. 1, and the communication section 500 may transmit the signal of control instructions to the electronic device(s) which are an object depending on the operation of the wearer based on the control screen.

Thereby, as shown in FIG. 7, it becomes possible that the user who is a wearer of the wearable device can control and operate the electronic device which is an object or an electronic device which is added to a non-electronic device as the object, (for example, apparatuses including the sensor which was installed in a garden tree). From the example of that the home electrical appliance is considered as an object, the object includes not only what things transmit information one-sidedly but also what things start or change the movement of itself by receiving a control signal (operation signal).Those apparatuses can be operated by performing the display of the control screen and transmitting a control signal. It is also enabled to use the wearable device like a wireless remote controller of other electronic devices.

Also, the display controller 400 may perform controlling to display an icon of the first to N representing an object of first to N (N being an integer that is 2 or more) as object information, and the display controller 400 may perform to control displaying the control screen used for the control instructions to the object of i corresponding to the icon of selected i when selection processing to select an icon of i (i being an integer that satisfies 1<=i<=N) from an icon of the first to N is performed.

Note that the term selection processing here is different from the selection processing of narrow sense, group classification processing or the priority setting processing. The term selection processing here is processing to determine one icon as the display object of the control screen from a plurality of icons.

Thereby, at first the icon of the candidate object is displayed and then it becomes possible to display the control screen of the object corresponding to the selected icon. As mentioned earlier, the example to skip an icon display by selecting one object automatically in the wearable device side is possible. However it can be possible to display the control screen of the object which fits the intention of the user more by performing an icon displaying and enabling the selection on it by the user.

Also, when the selection processing by the wearer is not carried out for a predetermined term after the displaying, the display controller 400 may perform selection processing to select one icon automatically and may perform to control displaying the control screen of the object corresponding to the selected icon.

Here, automatic selection is processing to determine one icon in the wearable device side. An icon selected by automatic selection may be determined by the wearable device. Also, it may be determined by the place which a cursor was located in at the time to start automatic selection.

Thereby, the control screen can be displayed automatically when the selection of the icon by the user is not performed. Thus, it is enabled to reduce complexity of the operation because a user does not need to perform selection processing expressly.

Also, the display controller 400 may perform to control displaying an icon representing an object as shown in FIG. 5 as object information, and the display controller 400 may display the icon of the object which is recognized by eyesight sensing and is not recognized by peripheral sensing in a first display mode and display in a second display mode the icon of the object which is recognized by peripheral sensing without being recognized by eyesight sensing (wherein the second display mode is different from the first display mode) and may perform to control displaying in a third mode the icon of the object which it is recognized by both eyesight sensing and peripheral sensing (wherein the third display mode is different from both the first display mode and the second display mode).

Thereby, it is enabled to display an icon which expresses an object as object information and to change display mode based on information whether or not the object was recognized in each of eyesight sensing and peripheral sensing. Thus, in the situation that can recognize many objects by fitting two sensing together, the information of many candidate objects can be shown to a user, and it is enabled to display comprehensibly the candidate object to a user such that it was recognized by which sensing respectively. Note that a difference of the display mode was expressed as a frame shape of the icons in FIG. 5, but it should not be limited to the display mode. It can be provided with a difference of display mode by various kinds of technique of size and the color of icon or the displaying position in the display area.

Also, the display controller 400 may select one object from candidate objects based on at least one of eyesight sensing information and peripheral sensing information and may perform to control displaying the object information of the selected object.

Thereby, one object can be selected from a plurality of candidate objects as a display object. Like the control screen and the detailed information including the names of the object (e.g., property screens), the thing that has much more information than icons may be considered as object information. In that case, it may not be realistic to display the object information of a plurality of objects at the same time because a size of the display 300 in the see-through type wearable device is limited. If it is displayed forcibly, there is a risk of a visibility drop of the information which a letter of that becomes small, for example. Thus, it may be important processing to narrow down the number of a candidate objects to one as display object. It is implemented as display control in the present embodiment.

Also, the eyesight sensor 100 may perform eyesight sensing acquiring a pickup image and may acquire eyesight sensing information based on the image processing to an acquired pickup image, and the peripheral sensing acquisition section 200 may acquire information about the strength of the signal as peripheral sensing information as a result of peripheral sensing receiving the signal from an object. And the display controller 400 may perform to control displaying the object information of a single selected object among the candidate objects, wherein a single object is judged to satisfy a condition that the single object is imaged by an pickup image based on eyesight sensing information, a signal of the single object is detected based on peripheral sensing information, and the angle of the single object to the eyes direction of the wearer is smaller than other objects from a candidate object based on at least one of eyesight sensing information and the peripheral sensing information.

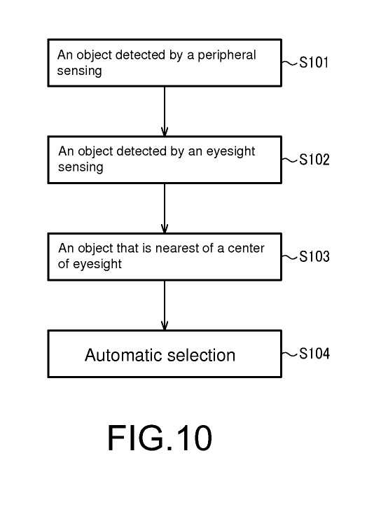

Thereby, in this example, the object which is assumed to be the highest interest degree to the user can be set as a display object when the object information of the single object is displayed. Specifically, after being recognized in both sensing, one object located in the direction that is the nearest to the eyes direction is set as a display object. FIG. 10 indicates a flow chart which shows a flow of the selection processing of this case. When this processing is started, judgment processing whether or not it was detected in peripheral sensing (S101), judgment processing whether or not it was detected in eyesight sensing (S102), judgment processing whether or not the eyes direction (the view center) of the wearer is the nearest (S103) and selection processing to automatically select one object meeting a condition (S104) are performed. However, as for the technique to determine the single object, it is conceivable in various ways. For example, the display controller 400 may select a single object from candidate objects based on a judgment of the pickup image based on eyesight sensing information and a stronger signal power than that of other objects based on peripheral sensing information and control displaying the object information of the selected object. In this case, it is used as the object that it is recognized by both eyesight sensing and peripheral sensing and it was judged to be nearest from the user as a result of the peripheral sensing.

Also, the display controller 400 may perform to control displaying property information of the object as object information.

Here, in one example, the property information is information about the characteristic(s) of the object and is information that is more detailed than the icons. For example, the icon may represent that an object is a refrigerator when a refrigerator is considered as an object, but the property information may include the name and a model number of the refrigerator or information acquired by a sensor.

Thereby, property information can be displayed as object information. Various kinds of information transmitted by an object is considered as property information. Such information may be, for example, provided on a property screen representing the property of the object and may be the sensor information of the sensor which an object was provided with and may be a processing result to the sensor information. One example case in which a processing result corresponding to the sensor information becomes the detailed information is as follows. For example, when it comes to acquiring a fluid volume of the soil of the garden plant as sensor information, the numerical value of the fluid volume may be output. In addition, a judgment whether the fluid volume is an appropriate range in consideration of the kind of the plant, outside temperature, a characteristic of the soil, etc. may be output.

Also, when the number of candidate objects is equal or more than the threshold value, the display controller 400 may perform to control displaying object information whose number is less than the threshold on the display 300 and display the number of the objects whose object information is out of displaying (not displayed) among candidate objects on the display 300.

Thereby, as shown in A4 of FIG. 5, when there are target objects which are recognized by sensing and are not becoming displaying objects, the number of the target objects can be displayed. Thus, the user can be notified of the existence of a recognized object while the object itself is non-display to a user and it is enabled in some cases to promote operation for displaying the object information of the object of the non-display to a user.

Note that a part of or most of the processing of the wearable devices of the present embodiment may be implemented by a program. In this case, wearable devices of the present embodiment are implemented by one or more processors such as CPU and so on that execute a program. Specifically, after a program stored by a non-temporary information storage medium is read by the processor(s), the processor(s) such as CPU's perform an operation of the program. Here, the information storage medium (the medium which is readable by a computer) stores a program or data, and the function can be implemented by an Optical Disk (DVD, CD), a HDD (hard disk drive), a memory (memory integrated circuit) or storage device (card type memory, ROM). And the processors such as CPU perform various kinds of processing of the present embodiment based on a program (data) stored by an information storage medium. That is, an information storage medium stores a program (program to make a computer perform processing of each section) to functionalize a computer (operating member, processing component, memory, device and comprising the output) as each section of the present embodiment.

The present embodiment is described in detail as above, but it will be readily appreciated to those skilled in the art that much transformation not to deviate from a new matter of the present invention and an effect substantially corresponding thereto is possible. Therefore, all such variations shall be within the range of the present invention. For example, in specification or drawings, the term described at least one time with a more wide sense or a synonymous different term can be rearranged in the different term in any place of specification or drawings. Also, it not limited to a thing described in the present embodiment about constitution or movement of wearable device and various kinds of transformation is possible.

What is claimed is:

1. A wearable device configured to be worn by a wearer, the wearable device comprising:
a display to provide an image on a display area that occupies a part of a field of view of the wearer,
an eyesight sensor to acquire eyesight sensing information by an eyesight sensing in a field of view of the eyesight sensor,
a peripheral sensing acquisition section to acquire peripheral sensing information from a peripheral sensing having a detection angle larger than an angle of the field of view of the eyesight sensor, and
a display controller to control displaying object information of an object in the image, the object being selected from at least one candidate object recognized by at least one of the eyesight sensing and the peripheral sensing.

2. The wearable device according to claim 1, wherein
the display controller controls displaying the object information of the object that is recognized by the eyesight sensing among the at least one candidate object.

3. The wearable device according to claim 1, wherein
the display controller controls displaying the object information of the object that is recognized by both the eyesight sensing and the peripheral sensing among the at least one candidate object.

4. The wearable device according to claim 1, wherein
the display controller controls displaying a control screen having a control instructions for controlling of the object whose object information is being displayed.

5. The wearable device according to claim 4, further including
a communication section configured to communicate with an electronic device as the object,
wherein the communication section is configured to transmit a signal of a control instruction to the electronic device based on an operation of the control screen by the wearer.

6. The wearable device according to claim 1, wherein
the eyesight sensor is configured to pick up an image in the field of view of the eyesight sensor as the eyesight sensing and acquire the eyesight sensing information based on image processing of the image.

7. The wearable device according to claim 1, wherein
the peripheral sensing acquisition section is configured to receive at least one signal concerning a position of the wearer and a position of the object so as to acquire information of a position of the object relative to a position of the wearer based on the signal received.

8. The wearable device according to claim 4, wherein
the display controller controls displaying an icon of one to N which expresses an object of one to N as the object information wherein N is an integer and is more than one, and
when a selection processing of selecting an icon i is performed among the icons of the one to N, the display controller controls displaying the control screen used as the control instruction of the object i corresponding to the icon i, wherein i is an integer satisfying 1≦i≦N.

9. The wearable device according to claim 8, wherein
when the selection is not performed by the wearer within a predetermined term, the display controller automatically selects a single icon among the icons and controls displaying the control screen of the object corresponding to the icon selected.

10. The wearable device according to claim 1,
wherein the display controller controls displaying an icon representing the object as the object information,
wherein, the display controller controls displaying the icon of the object as a first form, the object being recognized by the eyesight sensing and not recognized by the peripheral sensing,
wherein, the display controller controls displaying the icon of the object as a second form, the object being not recognized by the eyesight sensing and being recognized by the peripheral sensing, and
wherein the display controller controls displaying the icon of the object as a third form, the object being recognized by both the eyesight sensing and the peripheral sensing, the first form, the second form and the third form being different from each other.

11. The wearable device according to claim 1, wherein
the display controller selects a single object from the object comprising two or more candidate objects based on at least one of the eyesight sensing information and the peripheral sensing information and controls displaying of the object information of the single selected object.

12. The wearable device according to claim 11, wherein
the display controller selects the single object determined by at least one of:
a) a distance from the wearer being nearer than a distance of other candidate objects and
b) an angle from a front direction of the wearer being smaller than an angle from the front direction of the wearer of other candidate objects
and controls displaying the object information of the object selected based on at least one of the eyesight sensing information and the peripheral sensing information.

13. The wearable device according to claim 12, wherein
the display controller selects the single object determined by a distance from the wearer being nearer than a distance of other candidate objects based on at least one of the eyesight sensing information and the peripheral sensing information.

14. The wearable device according to claim 12, wherein
the display controller selects the single object determined by an angle from a front direction of the wearer being smaller than that of other candidate objects based on at least one of the eyesight sensing information and the peripheral sensing information.

15. The wearable device according to claim 1, wherein
the display controller controls displaying property information of the object as the object information.

16. The wearable device according to claim 1, wherein
when a number of the at least one candidate object is equal or more than a predetermined threshold value, the at least one candidate object being divided into a first group and a second group,
wherein the display controller controls displaying the object information in the first group, a number of the first group being less than the predetermined threshold value and
wherein the display controller controls displaying an indication of a number of the second group.

17. A computer program product storing a program code that, when executed by a computer, implements control of:
an eyesight sensor to acquire eyesight sensing information by an eyesight sensing in a field of view of the eyesight sensor,
a peripheral sensing acquisition section to acquire peripheral sensing information from a peripheral sensing having a detection angle larger than an angle of the field of view of the eyesight sensor, and
a display controller to control displaying object information of an object in the image, the object being selected from at least one candidate object recognized by at least one of the eyesight sensing and the peripheral sensing.

18. A display controlling method of a wearable device configured to be worn by a wearer, the wearable device having a display to provide an image on a display area that occupies a part of a field of view of the wearer, comprising:
acquiring eyesight sensing information by an eyesight sensing in a field of view of the eyesight sensing,
acquiring peripheral sensing information by a peripheral sensing having a detection angle larger than an angle of the field of view of the eyesight sensing, and
controlling displaying object information of an object in the image, the object being selected from at least one candidate object recognized by at least one of the eyesight sensing and the peripheral sensing.
